(19) United States
(12) Patent Application Publication
(10) Pub. No.: US 2014/0092961 A1
(43) Pub. Date: Apr. 3, 2014

(54) SIGNALING DECODER PICTURE BUFFER INFORMATION

(71) Applicant: SHARP LABORATORIES OF AMERICA, INC., Camas, WA (US)

(72) Inventors: Louis Joseph KEROFSKY, Camas, WA (US); Sachin G. DESHPANDE, Camas, WA (US)

(73) Assignee: SHARP LABORATORIES OF AMERICA, INC., Camas, WA (US)

(21) Appl. No.: 13/631,243

(22) Filed: Sep. 28, 2012

(51) Int. Cl. H04N 7/32

(52) U.S. Cl. 375/240.12; 375/E07.243

(57) ABSTRACT

A system for decoding a video bitstream includes receiving a frame of the video that includes at least one slice and at least one tile and where each of the at least one slice and the at least one tile are not all aligned with one another.

### CROSS-REFERENCE TO RELATED APPLICATIONS

None.

### BACKGROUND OF THE INVENTION

The present invention relates to video encoding and decoding.

Electronic devices have become smaller and more powerful in order to meet consumer needs and to improve portability and convenience. Consumers have become dependent upon electronic devices and have come to expect increased functionality Some examples of electronic devices include desktop computers, laptop computers, cellular phones, smart phones, media players, integrated circuits, etc.

Some electronic devices are used for processing and/or displaying digital media. For example, portable electronic devices now allow for digital media to be produced and/or consumed at almost any location where a consumer may be. Furthermore, some electronic devices may provide download or streaming of digital media content for the use and enjoyment of a consumer.

Digital video is typically represented as a series of images or frames, each of which contains an array of pixels. Each pixel includes information, such as intensity and/or color information. In many cases, each pixel is represented as a set of three colors, each of which is defined by eight bit color values. Some video coding techniques provide higher coding efficiency at the expense of increasing complexity. Increasing image quality requirements and increasing image resolution requirements for video coding techniques also increase the coding complexity.

The increasing popularity of digital media has presented several problems. For example, efficiently representing high-quality digital media for storage, transmittal, and playback presents several challenges. Techniques that represent digital media more efficiently is beneficial.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a block diagram illustrating one configuration of an electronic device including a HEVC encoder.

FIG. 2 is a block diagram illustrating one configuration of an electronic device including a HEVC decoder.

FIG. 3 is a block diagram illustrating one example of a coder and a decoder.

FIG. 4 illustrates various components that may be utilized in an electronic device.

FIG. 5 illustrates an exemplary slice structure.

FIG. 6 illustrates another exemplary slice structure.

FIG. 7 illustrates a frame with a slice and 9 tiles.

FIG. 8 illustrates a frame with three slices and 3 tiles.

FIG. 9 illustrates level limits for an encoding and decoding system.

FIG. 10 illustrates different maximum decoder picture buffer sizes.

### DETAILED DESCRIPTION OF PREFERRED EMBODIMENT

The Joint Collaborative Team on Video Coding (JCT-VC) of the International Telecommunication Union Telecommunication Standardization Sector (ITU-T) Study Group 16 (SG16) Working Party 3 (WP3) and International Organization for Standardization/International Electrotechnical Commission (ISO/IEC) Joint Technical Committee 1/Subcommittee 29/Working Group 11 (JTC1/SC29/WG11) has launched a standardization effort for a video coding standard called the High Efficiency Video Coding standard (HEVC). HEVC uses block-based coding.

In HEVC, two entropy coding techniques (e.g., Context-Adaptive Variable Length Coding (CAVLC) and Context-Adaptive Binary Arithmetic Coding CABAC)) are used to compress Transformed and Quantized Coefficients (TQCs) without loss. TQCs may be from different block sizes according to transform sizes (e.g., 4×4, 8×8, 16×16, 32×32).

Two-dimensional (2D) TQCs may be converted into a one-dimensional (1D) array before entropy coding. In one example, 2D arrayed TQCs in a 4×4 block may be arranged as illustrated in Table (1).

TABLE (1)

| | | | |
|---|---|---|---|
| 4 | 0 | 1 | 0 |
| 3 | 2 | −1 | . . . |
| −3 | 0 | . . . | . . . |
| 0 | . . . | . . . | . . . |

When converting the 2D TQCs into a 1D array, the block may be scanned in a diagonal zig-zag fashion. Continuing with the example, the 2D arrayed TQCs illustrated in Table (1) may be converted into 1D arrayed TQCs [4, 0, 3, −3, 2, 1, 0, −1, 0, . . . ] by scanning the first row and first column, first row and second column, second row and first column, third row and first column, second row and second column, first row and third column, first row and fourth column, second row and third column, third row and second column, fourth row and first column and so on.

The CAVLC coding procedure in HEVC may proceed, for example, as follows. The TQCs in the 1D array may be ordered according to scanning position. The scanning position of the last significant coefficient and the last coefficient level may be determined. The last significant coefficient may be coded. It should be noted that coefficients are typically coded in reverse scanning order. Run-level coding may be performed, which is activated directly after the last coefficient coding. Then, level coding may be performed. The term significant coefficient refers to a coefficient that has a coefficient level value that is greater than zero. A coefficient level value refers to a unique indicator of the magnitude (or absolute value) of a Transformed and Quantized Coefficient (TQC) value.

This procedure may be illustrated in Table (2) as a continuation of the example above (with the 1D arrayed TQCs [4, 0, 3, −3, 2, 1, 0, −1, 0, . . . ]).

TABLE (2)

| | | | | | | | | | |
|---|---|---|---|---|---|---|---|---|---|
| Scanning Position | 0 | 1 | 2 | 3 | 4 | 5 | 6 | 7 | . . . |
| Coefficient Level | 4 | 0 | 3 | −3 | 2 | 1 | 0 | −1 | . . . |
| Last Position | | | | | | | | 7 | |
| Last Coefficient Level | | | | | | | | −1 | |
| Run-Level Coding | | | | | 2 | 1 | 0 | | |
| Level Coding | 4 | 0 | 3 | −3 | | | | | |

In Table (2), for example, the coefficient level −1 at scanning position 7 may be the last non-zero coefficient. Thus, the last position is scanning position 7 and the last coefficient level is −1. Run-level coding may be performed for coefficients 0, 1 and 2 at scanning positions 6, 5 and 4 (where coefficients are coded in reverse scanning order). Then, level coding may be performed for the coefficient levels −3, 3, 0 and 4.

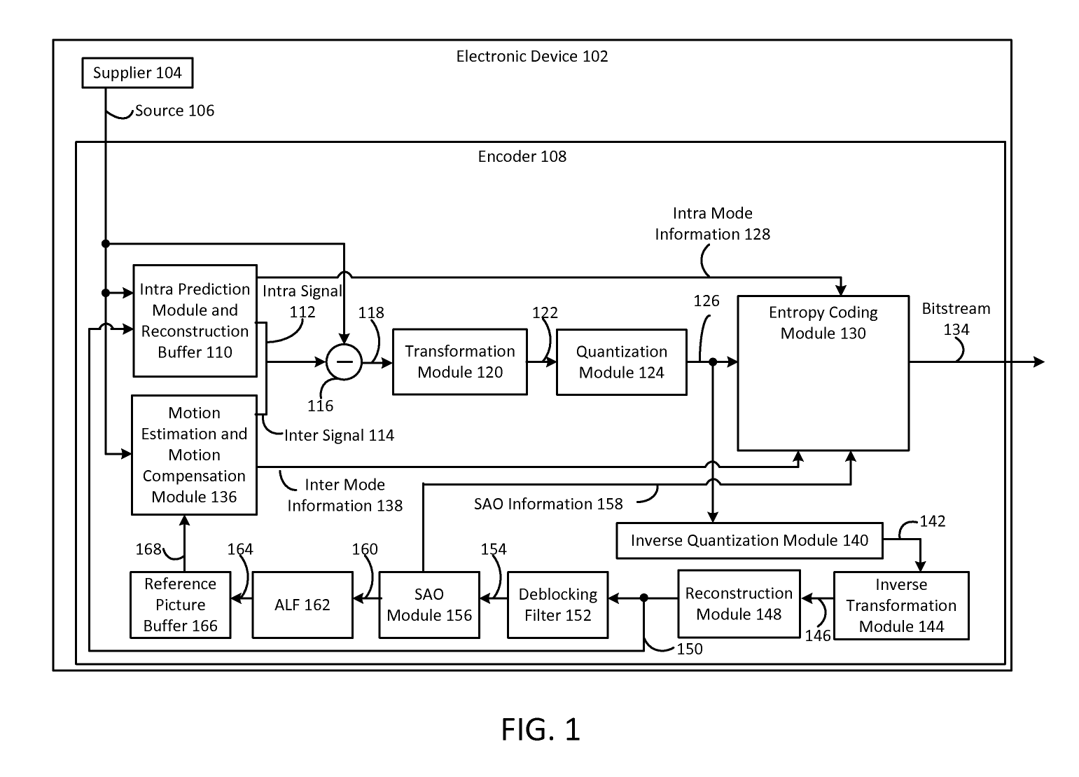

FIG. 1 is a block diagram illustrating one configuration of an electronic device 102 in which video may be coded. It should be noted that one or more of the elements illustrated as included within the electronic device 102 may be implemented in hardware, software, or a combination of both. For example, the electronic device 102 includes a coder 108, which may be implemented in hardware, software or a combination of both. For instance, the coder 108 may be implemented as a circuit, integrated circuit, application-specific integrated circuit (ASIC), processor in electronic communication with memory with executable instructions, firmware, field-programmable gate array (FPGA), etc., or a combination thereof. In some configurations, the coder 108 may be a high efficiency video coding (HEVC) coder.

The electronic device 102 may include a supplier 104. The supplier 104 may provide picture or image data (e.g., video) as a source 106 to the coder 108. Examples of the supplier 104 include image sensors, memory, communication interfaces, network interfaces, wireless receivers, ports, etc.

The source 106 may be provided to an intra-frame prediction module and reconstruction buffer 110. The source 106 may also be provided to a motion estimation and motion compensation module 136 and to a subtraction module 116.

The intra-frame prediction module and reconstruction buffer 110 may generate intra mode information 128 and an intra signal 112 based on the source 106 and reconstructed data 150. The motion estimation and motion compensation module 136 may generate inter mode information 138 and an inter signal 114 based on the source 106 and a reference picture buffer 166 signal 168. The reference picture buffer 166 signal 168 may include data from one or more reference pictures stored in the reference picture buffer 166.

The coder 108 may select between the intra signal 112 and the inter signal 114 in accordance with a mode. The intra signal 112 may be used in order to exploit spatial characteristics within a picture in an intra coding mode. The inter signal 114 may be used in order to exploit temporal characteristics between pictures in an inter coding mode. While in the intra coding mode, the intra signal 112 may be provided to the subtraction module 116 and the intra mode information 128 may be provided to an entropy coding module 130. While in the inter coding mode, the inter signal 114 may be provided to the subtraction module 116 and the inter mode information 138 may be provided to the entropy coding module 130.

Either the intra signal 112 or the inter signal 114 (depending on the mode) is subtracted from the source 106 at the subtraction module 116 in order to produce a prediction residual 118. The prediction residual 118 is provided to a transformation module 120. The transformation module 120 may compress the prediction residual 118 to produce a transformed signal 122 that is provided to a quantization module 124. The quantization module 124 quantizes the transformed signal 122 to produce transformed and quantized coefficients (TQCs) 126.

The TQCs 126 are provided to an entropy coding module 130 and an inverse quantization module 140. The inverse quantization module 140 performs inverse quantization on the TQCs 126 to produce an inverse quantized signal 142 that is provided to an inverse transformation module 144. The inverse transformation module 144 decompresses the inverse quantized signal 142 to produce a decompressed signal 146 that is provided to a reconstruction module 148.

The reconstruction module 148 may produce reconstructed data 150 based on the decompressed signal 146. For example, the reconstruction module 148 may reconstruct (modified) pictures. The reconstructed data 150 may be provided to a deblocking filter 152 and to the intra prediction module and reconstruction buffer 110. The deblocking filter 152 may produce a filtered signal 154 based on the reconstructed data 150.

The filtered signal 154 may be provided to a sample adaptive offset (SAO) module 156. The SAO module 156 may produce SAO information 158 that is provided to the entropy coding module 130 and an SAO signal 160 that is provided to an adaptive loop filter (ALF) 162. The ALF 162 produces an ALF signal 164 that is provided to the reference picture buffer 166. The ALF signal 164 may include data from one or more pictures that may be used as reference pictures. In some cases the ALF 162 may be omitted.

The entropy coding module 130 may code the TQCs 126 to produce a bitstream 134. As described above, the TQCs 126 may be converted to a 1D array before entropy coding. Also, the entropy coding module 130 may code the TQCs 126 using CAVLC or CABAC. In particular, the entropy coding module 130 may code the TQCs 126 based on one or more of intra mode information 128, inter mode information 138 and SAO information 158. The bitstream 134 may include coded picture data.

Quantization, involved in video compression such as HEVC, is a lossy compression technique achieved by compressing a range of values to a single quantum value. The quantization parameter (QP) is a predefined scaling parameter used to perform the quantization based on both the quality of reconstructed video and compression ratio. The block type is defined in HEVC to represent the characteristics of a given block based on the block size and its color information. QP, resolution information and block type may be determined before entropy coding. For example, the electronic device 102 (e.g., the coder 108) may determine the QP, resolution information and block type, which may be provided to the entropy coding module 130.

The entropy coding module 130 may determine the block size based on a block of TQCs 126. For example, block size may be the number of TQCs 126 along one dimension of the block of TQCs. In other words, the number of TQCs 126 in the block of TQCs may be equal to block size squared. For instance, block size may be determined as the square root of the number of TQCs 126 in the block of TQCs. Resolution may be defined as a pixel width by a pixel height. Resolution information may include a number of pixels for the width of a picture, for the height of a picture or both. Block size may be defined as the number of TQCs along one dimension of a 2D block of TQCs.

In some configurations, the bitstream 134 may be transmitted to another electronic device. For example, the bitstream 134 may be provided to a communication interface, network interface, wireless transmitter, port, etc. For instance, the bitstream 134 may be transmitted to another electronic device via a Local Area Network (LAN), the Internet, a cellular phone base station, etc. The bitstream 134 may additionally or alternatively be stored in memory on the electronic device 102.

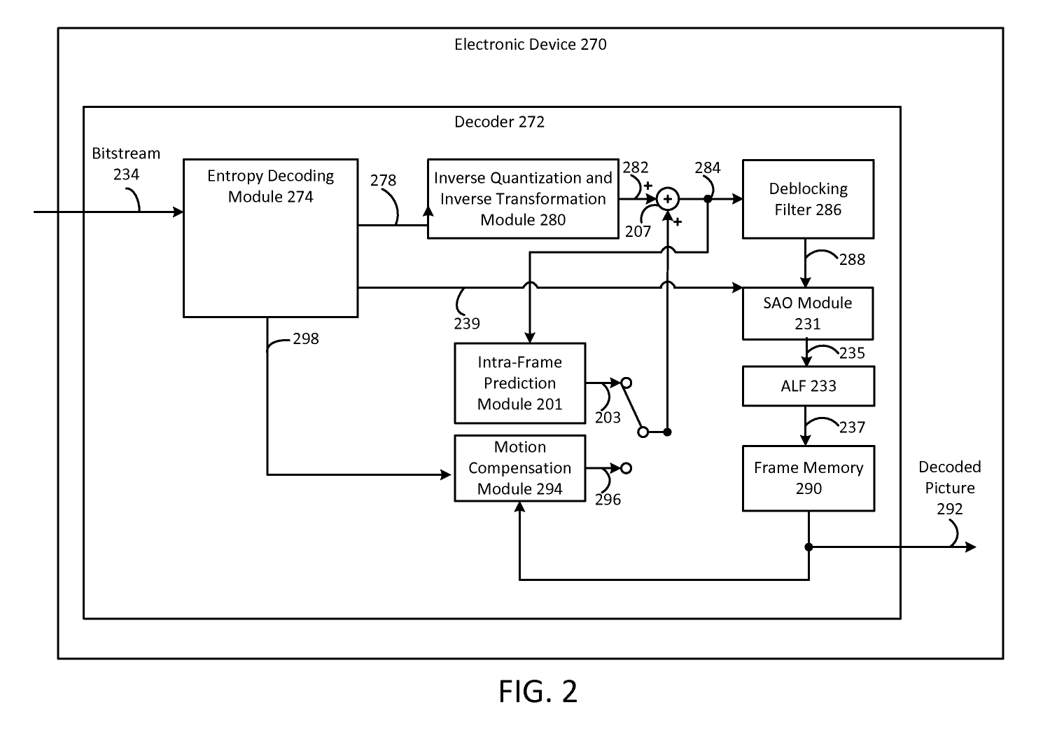

FIG. 2 is a block diagram illustrating one configuration of an electronic device 270 including a decoder 272 that may be a high-efficiency video coding (HEVC) decoder. The decoder 272 and one or more of the elements illustrated as included in the decoder 272 may be implemented in hardware, software or a combination of both. The decoder 272 may receive a bitstream 234 (e.g., one or more coded pictures included in the bitstream 234) for decoding. In some configurations, the received bitstream 234 may include received overhead information, such as a received slice header, received picture parameter set (PPS), received buffer description information, classification indicator, etc.

Received symbols (e.g., encoded TQCs) from the bitstream 234 may be entropy decoded by an entropy decoding module 274. This may produce a motion information signal 298 and decoded transformed and quantized coefficients (TQCs) 278.

The motion information signal 298 may be combined with a portion of a decoded picture 292 from a frame memory 290 at a motion compensation module 294, which may produce an inter-frame prediction signal 296. The decoded transformed and quantized coefficients (TQCs) 278 may be inverse quantized and inverse transformed by an inverse quantization and inverse transformation module 280, thereby producing a decoded residual signal 282. The decoded residual signal 282 may be added to a prediction signal 205 by a summation module 207 to produce a combined signal 284. The prediction signal 205 may be a signal selected from either the inter-frame prediction signal 296 produced by the motion compensation module 294 or an intra-frame prediction signal 203 produced by an intra-frame prediction module 201. In some configurations, this signal selection may be based on (e.g., controlled by) the bitstream 234.

The intra-frame prediction signal 203 may be predicted from previously decoded information from the combined signal 284 (in the current frame, for example). The combined signal 284 may also be filtered by a deblocking filter 286. The resulting filtered signal 288 may be provided to a sample adaptive offset (SAO) module 231. Based on the filtered signal 288 and information 239 from the entropy decoding module 274, the SAO module 231 may produce an SAO signal 235 that is provided to an adaptive loop filter (ALF) 233. The ALF 233 produces an ALF signal 237 that is provided to the frame memory 290. The ALF signal 237 may include data from one or more pictures that may be used as reference pictures. The ALF signal 237 may be written to frame memory 290. The resulting ALF signal 237 may include a decoded picture. In some cases the ALF 233 may be omitted.

The frame memory 290 may include a decoded picture buffer (DPB). The frame memory 290 may also include overhead information corresponding to the decoded pictures. For example, the frame memory 290 may include slice headers, picture parameter set (PPS) information, cycle parameters, buffer description information, etc. One or more of these pieces of information may be signaled from a coder (e.g., coder 108).

The frame memory 290 may provide one or more decoded pictures 292 to the motion compensation module 294. Furthermore, the frame memory 290 may provide one or more decoded pictures 292, which may be output from the decoder 272. The one or more decoded pictures 292 may be presented on a display, stored in memory or transmitted to another device, for example.

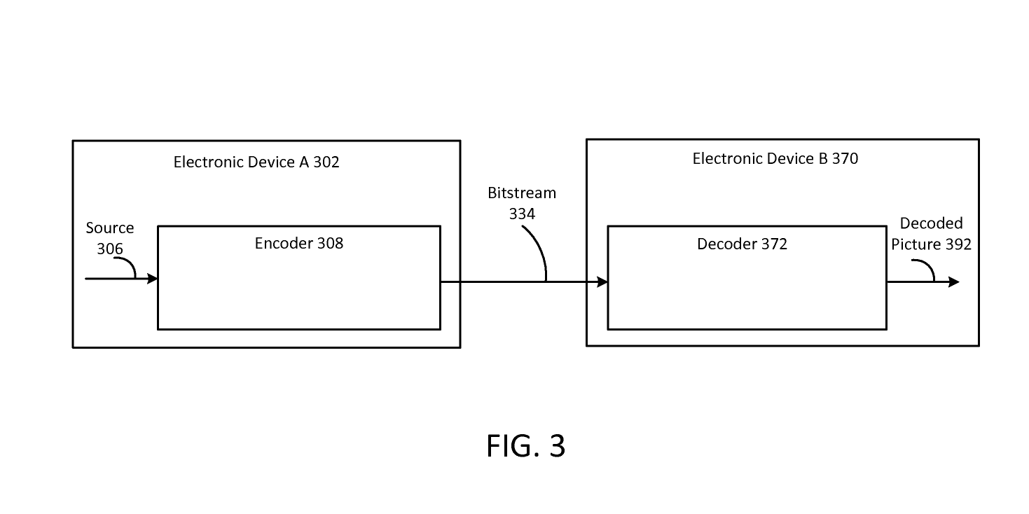

FIG. 3 is a block diagram illustrating one example of a coder 308 and a decoder 372. In this example, electronic device A 302 and electronic device B 370 are illustrated. However, it should be noted that the features and functionality described in relation to electronic device A 302 and electronic device B 370 may be combined into a single electronic device in some configurations.

Electronic device A 302 includes the coder 308. The coder 308 may be implemented in hardware, software or a combination of both. In one configuration, the coder 308 may be a high-efficiency video coding (HEVC) coder. Other coders may likewise be used. Electronic device A 302 may obtain a source 306. In some configurations, the source 306 may be captured on electronic device A 302 using an image sensor, retrieved from memory or received from another electronic device.

The coder 308 may code the source 306 to produce a bitstream 334. For example, the coder 308 may code a series of pictures (e.g., video) in the source 306. The coder 308 may be similar to the coder 108 described above in connection with FIG. 1.

The bitstream 334 may include coded picture data based on the source 306. In some configurations, the bitstream 334 may also include overhead data, such as slice header information, PPS information, etc. As additional pictures in the source 306 are coded, the bitstream 334 may include one or more coded pictures.

The bitstream 334 may be provided to the decoder 372. In one example, the bitstream 334 may be transmitted to electronic device B 370 using a wired or wireless link. In some cases, this may be done over a network, such as the Internet or a Local Area Network (LAN). As illustrated in FIG. 3, the decoder 372 may be implemented on electronic device B 370 separately from the coder 308 on electronic device A 302. However, it should be noted that the coder 308 and decoder 372 may be implemented on the same electronic device in some configurations. In an implementation where the coder 308 and decoder 372 are implemented on the same electronic device, for instance, the bitstream 334 may be provided over a bus to the decoder 372 or stored in memory for retrieval by the decoder 372.

The decoder 372 may be implemented in hardware, software or a combination of both. In one configuration, the decoder 372 may be a high-efficiency video coding (HEVC) decoder. Other decoders may likewise be used. The decoder 372 may be similar to the decoder 272 described above in connection with FIG. 2.

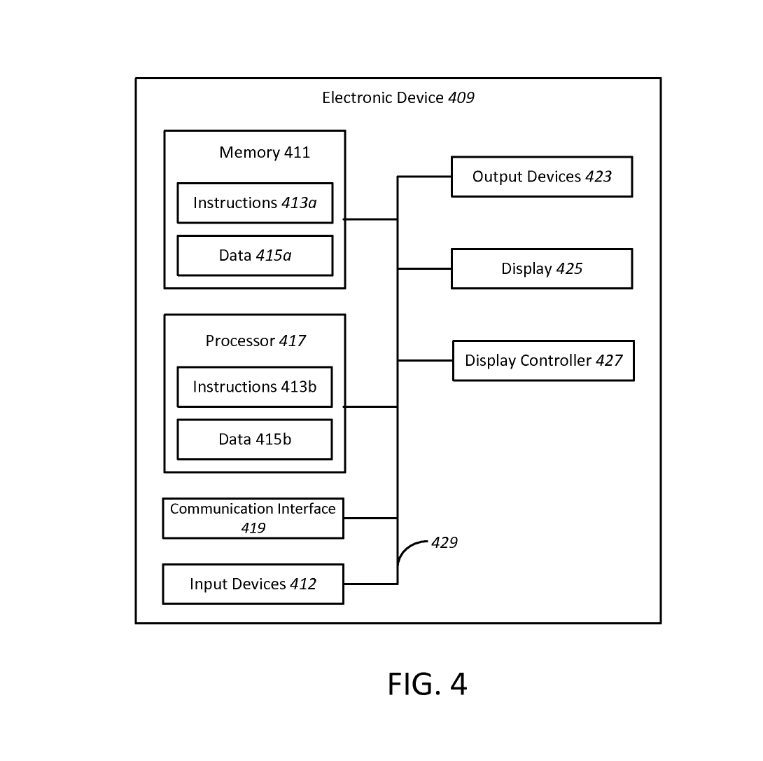

FIG. 4 illustrates various components that may be utilized in an electronic device 409. The electronic device 409 may be implemented as one or more of the electronic devices. For example, the electronic device 409 may be implemented as the electronic device 102 described above in connection with FIG. 1, as the electronic device 270 described above in connection with FIG. 2, or both.

The electronic device 409 includes a processor 417 that controls operation of the electronic device 409. The processor 417 may also be referred to as a CPU. Memory 411, which may include both read-only memory (ROM), random access memory (RAM) or any type of device that may store information, provides instructions 413a (e.g., executable instructions) and data 415a to the processor 417. A portion of the memory 411 may also include non-volatile random access memory (NVRAM). The memory 411 may be in electronic communication with the processor 417.

Instructions 413b and data 415b may also reside in the processor 417. Instructions 413b and/or data 415b loaded into the processor 417 may also include instructions 413a and/or data 415a from memory 411 that were loaded for execution or processing by the processor 417. The instructions 413b may be executed by the processor 417 to implement one or more techniques disclosed herein.

The electronic device 409 may include one or more communication interfaces 419 for communicating with other electronic devices. The communication interfaces 419 may be based on wired communication technology, wireless communication technology, or both. Examples of communication interfaces 419 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, a wireless transceiver in accordance with 3^{rd} Generation Partnership Project (3GPP) specifications and so forth.

The electronic device 409 may include one or more output devices 423 and one or more input devices 421. Examples of output devices 423 include a speaker, printer, etc. One type of output device that may be included in an electronic device 409 is a display device 425. Display devices 425 used with configurations disclosed herein may utilize any suitable image projection technology, such as a cathode ray tube (CRT), liquid crystal display (LCD), light-emitting diode (LED), gas plasma, electroluminescence or the like. A display controller 427 may be provided for converting data stored in the memory 411 into text, graphics, and/or moving images (as appropriate) shown on the display 425. Examples of input devices 421 include a keyboard, mouse, microphone, remote control device, button, joystick, trackball, touchpad, touchscreen, lightpen, etc.

The various components of the electronic device 409 are coupled together by a bus system 429, which may include a power bus, a control signal bus and a status signal bus, in addition to a data bus. However, for the sake of clarity, the various buses are illustrated in FIG. 4 as the bus system 429. The electronic device 409 illustrated in FIG. 4 is a functional block diagram rather than a listing of specific components.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. The code for the decoder and/or encoder may be stored on a computer readable medium.

An input picture comprising a plurality of coded tree blocks (e.g., generally referred to herein as blocks) may be partitioned into one or several slices. The values of the samples in the area of the picture that a slice represents may be properly decoded without the use of data from other slices provided that the reference pictures used at the encoder and the decoder are the same and that de-blocking filtering does not use information across slice boundaries. Therefore, entropy decoding and block reconstruction for a slice does not depend on other slices. In particular, the entropy coding state may be reset at the start of each slice. The data in other slices may be marked as unavailable when defining neighborhood availability for both entropy decoding and reconstruction. The slices may be entropy decoded and reconstructed in parallel. No intra prediction and motion-vector prediction is preferably allowed across the boundary of a slice. In contrast, de-blocking filtering may use information across slice boundaries.

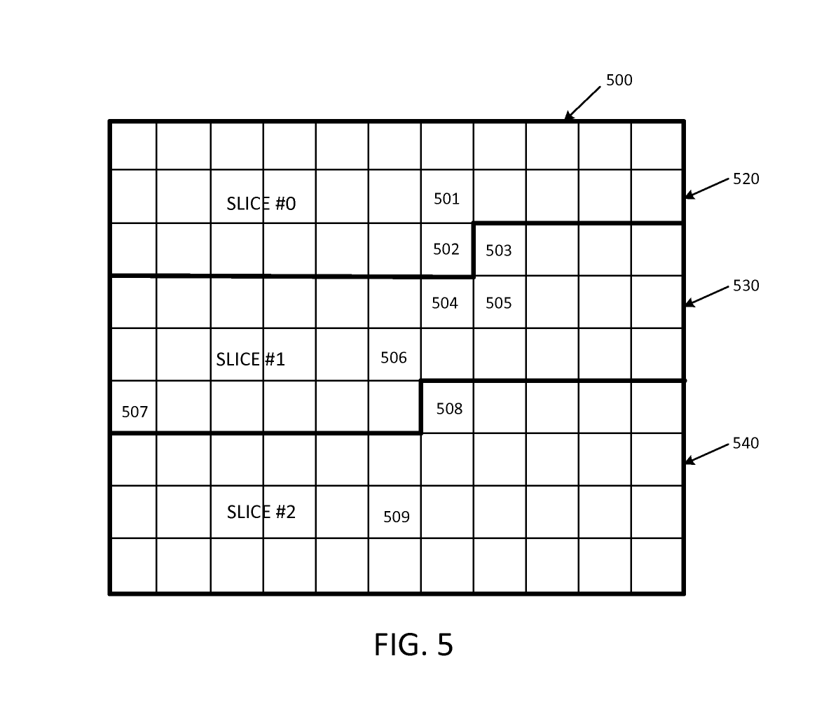

FIG. 5 illustrates an exemplary video picture 500 comprising eleven blocks in the horizontal direction and nine blocks in the vertical direction (nine exemplary blocks labeled 501-509). FIG. 5 illustrates three exemplary slices: a first slice denoted “SLICE #0” 520, a second slice denoted “SLICE #1” 530 and a third slice denoted “SLICE #2” 540. The decoder may decode and reconstruct the three slices 520, 530, 540, in parallel. Each of the slices may be transmitted in scan line order in a sequential manner. At the beginning of the decoding/reconstruction process for each slice, context models are initialized or reset and blocks in other slices are marked as unavailable for both entropy decoding and block reconstruction. The context model generally represents the state of the entropy encoder and/or decoder. Thus, for a block, for example, the block labeled 503, in “SLICE #1”, blocks (for example, blocks labeled 501 and 502) in “SLICE #0” may not be used for context model selection or reconstruction. Whereas, for a block, for example, the block labeled 505, in “SLICE #1,” other blocks (for example, blocks labeled 503 and 504) in “SLICE #1” may be used for context model selection or reconstruction. Therefore, entropy decoding and block reconstruction proceeds serially within a slice. Unless slices are defined using a flexible block ordering (FMO), blocks within a slice are processed in the order of a raster scan.

Flexible block ordering defines a slice group to modify how a picture is partitioned into slices. The blocks in a slice group are defined by a block-to-slice-group map, which is signaled by the content of the picture parameter set and additional information in the slice headers. The block-to-slice-group map consists of a slice-group identification number for each block in the picture. The slice-group identification number specifies to which slice group the associated block belongs. Each slice group may be partitioned into one or more slices, wherein a slice is a sequence of blocks within the same slice group that is processed in the order of a raster scan within the set of blocks of a particular slice group. Entropy decoding and block reconstruction proceeds serially within a slice group.

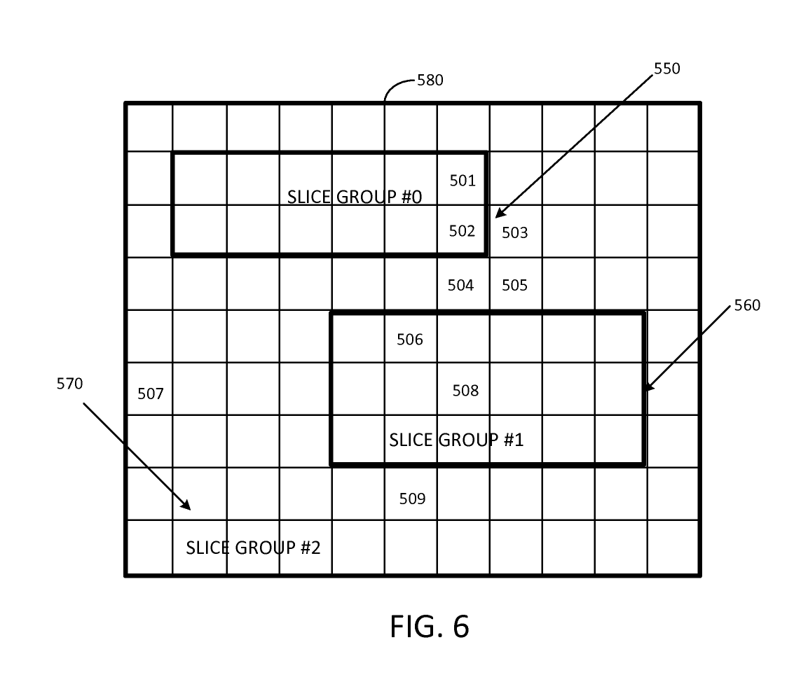

FIG. 6 depicts an exemplary block allocation into three slice groups: a first slice group denoted “SLICE GROUP #0” 550, a second slice group denoted “SLICE GROUP #1” 560 and a third slice group denoted “SLICE GROUP #2” 570. These slice groups 550, 560, 570, may be associated with two foreground regions and a background region, respectively, in the picture 580.

The arrangement of slices, as illustrated in FIG. 5, may be limited to defining each slice between a pair of blocks in the image scan order, also known as raster scan or a raster scan order. This arrangement of scan order slices is computationally efficient but does not tend to lend itself to the highly efficient parallel encoding and decoding. Moreover, this scan order definition of slices also does not tend to group smaller localized regions of the image together that are likely to have common characteristics highly suitable for coding efficiency. The arrangement of slices, as illustrated in FIG. 6, is highly flexible in its arrangement but does not tend to lend itself to high efficient parallel encoding or decoding. Moreover, this highly flexible definition of slices is computationally complex to implement in a decoder.

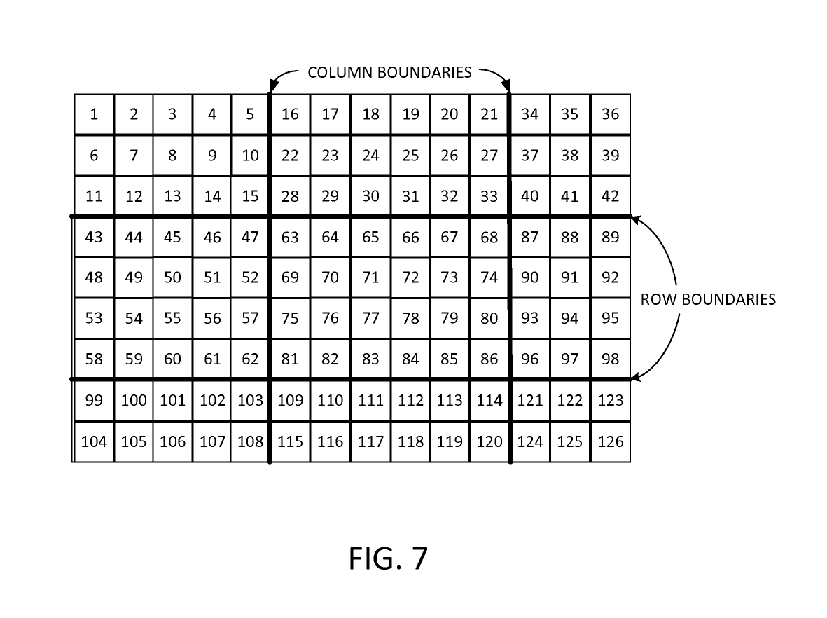

Referring to FIG. 7, a tile technique divides an image into a set of rectangular (inclusive of square) regions. The blocks (alternatively referred to as largest coding units or coded treeblocks in some systems) within each of the tiles are encoded and decoded in a raster scan order. The arrangement of tiles are likewise encoded and decoded in a raster scan order. Accordingly, there may be any suitable number of column boundaries (e.g., 0 or more) and there may be any suitable number of row boundaries (e.g., 0 or more). Thus, the frame may define one or more slices, such as the one slice illustrated in FIG. 7. In some embodiments, blocks located in different tiles are not available for intra-prediction, motion compensation, entropy coding context selection or other processes that rely on neighboring block information.

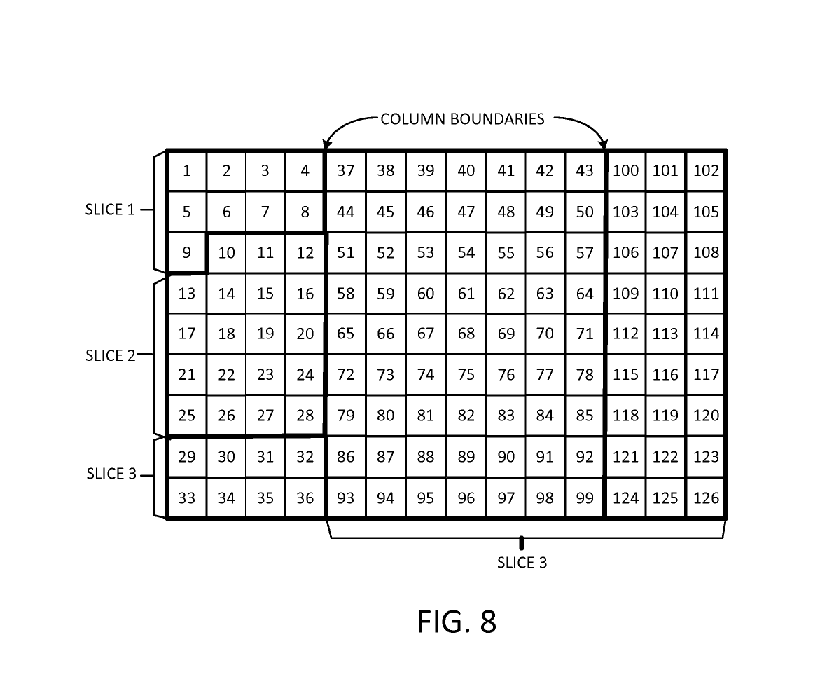

Referring to FIG. 8, the tile technique is shown dividing an image into a set of three rectangular columns The blocks (alternatively referred to as largest coding units or coded treeblocks in some systems) within each of the tiles are encoded and decoded in a raster scan order. The tiles are likewise encoded and decoded in a raster scan order. One or more slices may be defined in the scan order of the tiles. Each of the slices are independently decodable. For example, slice 1 may be defined as including blocks 1-9, slice 2 may be defined as including blocks 10-28, and slice 3 may be defined as including blocks 29-126 which spans three tiles. The use of tiles facilitates coding efficiency by processing data in more localized regions of a frame.

It is to be understood that in some cases the video coding may optionally not include tiles, and may optionally include the use of a wave front encoding/decoding pattern for the frames of the video. In this manner, one or more lines of the video (such as a plurality of groups of one or more rows of macroblocks (or alternatively coded tree blocks), each of which group being representative of a wavefront substream may be encoded/decoded in a parallel fashion. In general, the partitioning of the video may be constructed in any suitable manner.

Video coding standards often compress video data for transmission over a channel with limited frequency bandwidth and/or limited storage capacity. These video coding standards may include multiple coding stages such as intra prediction, transform from spatial domain to frequency domain, quantization, entropy coding, motion estimation, and motion compensation, in order to more effectively encode and decode frames. Many of the coding and decoding stages are unduly computationally complex.

The reference picture buffer 166 may also be referred generally as a decoded picture buffer since the frames are not necessarily used as a reference. The decoder likewise includes a reference picture buffer and/or decoded picture buffer in the frame memory 290. In many cases, the decoded picture buffer will decode frames in an out of order manner or otherwise maintain frames for later use. In general, coding efficiency is improved when the number of reference frames increases. However, typically decoders have more constraints than encoders in desired complexity and memory limitations. One such constraint is the size of the decoded picture buffer (DPB), which contains reconstructed pictures that are used in the coding and decoding of subsequent frames Such constraints at the decoder limit the use of reconstructed pictures as reference pictures and the number of buffered pictures. With such constraints, the worst case size of the decoded picture buffer necessary to decode a bitstream should be selected in an appropriate manner. B. Bros, W-J. Han, J-R. Ohm, G. J. Sullivan, and T-. Wiegand, “High efficiency video coding (HEVC) text specification draft 8,” JCTVC-J10003, Stockholj, July 2012 is hereby incorporated by reference herein in its entirety.

A variable value of sps_max_dec_pic_buffering[i] may be used to specify the maximum required size of the decoded picture buffer in units of picture storage buffers when HighestTid is equal to i. Larger pictures result in fewer picture storage buffers that may be used, and smaller pictures results in greater picture storage buffers that may be used. The value of sps_max_dec_pic_buffering[i] is in the range of 0 to MaxDpbSize. HightestTid refers to the highest temporal identification in a video sequence which is related to the frame rate of the decoded frames (e.g., places a bound on the frame rate). MaxDpbSize relates to the size of the decoded picture buffer, such as the number of frames that may be buffered.

For example, MaxDpbSize may be specificed as follows when the bit depth is equal to 8 and the chroma format of the picture is 4:2:0.

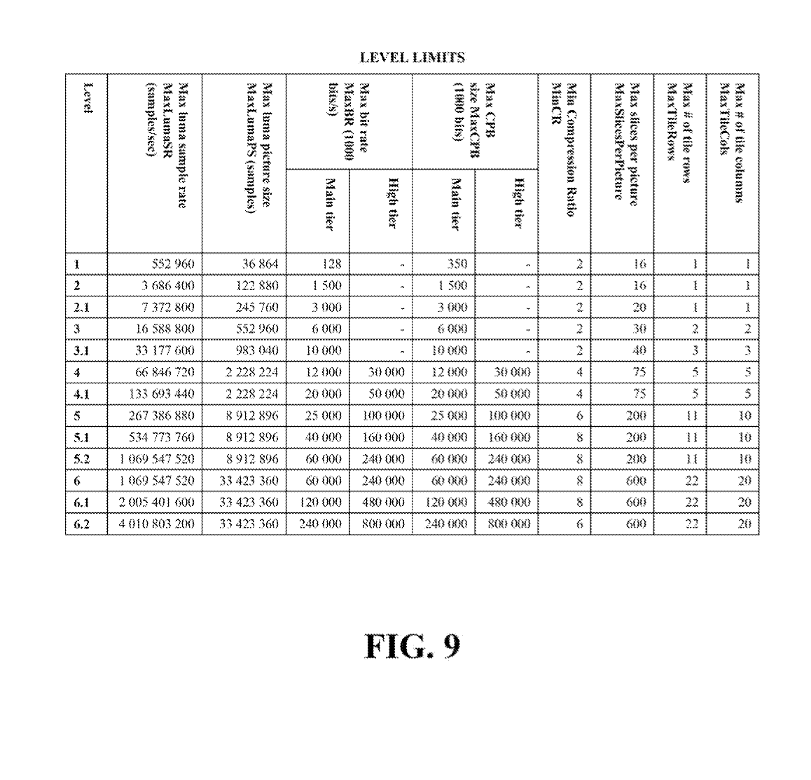

```
  if ( PicSizeInSamplesY <= ( MaxLumaPS >> 2) )
    MaxDpbSize = Min( 4 * MaxDpbPicBuf, 16 )
  else if ( PicSizeInSamplesY <= ( MaxLumaPS >> 1 ) )
    MaxDpbSize = Min( 2 * MaxDpbPicBuf, 16 )
  else if ( PicSizeInSamplesY <= ( MaxLumaPS << 1) / 3 )
    MaxDpbSize = Min( (3 * MaxDpbPicBuf) >> 1, 16 )
  else if ( PicSizeInSamplesY <= ( ( 3 * MaxLumaPS ) >> 2) )
    MaxDpbSize = Min( (4 * MaxDpbPicBuf) / 3, 16 )
  else
    MaxDpbSize = MaxDpbPicBuf
  where MaxLumaPS is specified in FIG. 9 and MaxDpbPicBuf is equal to
6.
```

PicSizeInSamplesY is the pic_width_in_luma_samples (i.e., picture width in terms of luminance samples) *pic_height_in_luma_samples (i.e., picture height in terms of luminance samples) of the picture in the current bitstream, which is generally the number of pixels of a picture in the video sequence since each pixel typically has a luminance component. Referring to FIG. 9, MaxLumaPS is a maximum luminance picture size selected based upon the encoding level being used. MaxDpbPicBuf is set to a suitable value, such as 6, is a parameter to the MaxDpbSize calculation.

With MaxDpbPicBuf having a value of 6, the following values are determined:

MaxDpbSize = Min( 4 * MaxDpbPicBuf, 16 ) is 16;
MaxDpbSize = Min( 2 * MaxDpbPicBuf, 16) is 12;
MaxDpbSize = Min( (3 * MaxDpbPicBuf) >> 1, 16 ) is 9;
MaxDpbSize = Min( (4 * MaxDpbPicBuf) / 3, 16) is 8;
Otherwise, MaxDpbSize = MaxDpbPicBuf is 6.

The chroma format 4:2:0 generally refers to a subsampling scheme that describes the number of luminance and chrominance samples in a conceptual region that is 4 pixels wide and 2 pixels high. In this case 4 is the horizontal sampling reference (width of the conceptual region), 2 is the number of chrominance samples in the first row of 4 pixels, and 0 is the number of additional chrominance samples in the second row of 4 pixels. In this manner, there are 6 samples for each group of 4 pixels, with a bit depth of 8 bits each sample requires 1 byte. Hence 6 bytes are required for each group of four pixels.

It was determined that the number of samples used in the chroma format, together with the bit depth of the pixels, should be used to determine the maximum size of the decoder picture buffer in terms of picture storage buffers. For example, if the number of samples used in the chroma format is reduced then the maximum size of the decoder picture buffer in terms of the number of picture storage buffers is preferably increased. Contrary for example, if the number of samples used in the chroma format is increased then the maximum size of the decoder picture buffer in terms of the number of picture storage buffers is preferably decreased. In this manner, the size of the decoder picture buffer in terms of the number of picture storage buffers may be more appropriately selected based upon the chroma format of the video. In a similar manner, the bit depth of the video may likewise be used.

For example, sps_max_dec_pic_buffering[HighestTid]<=MaxDpbSize, where MaxDpbSize is derived as specified by (1) the bit depth is >8 and <=16 so each sample requires 2 bytes and chroma format is 4:2:0 so there are 6 samples for each group of 4 pixels, or (2) the bit depth is 8 and chroma format is 4:4:4. Chroma format 4:4:4 does not include subsampling, and therefore the number of samples would be 12 for each group of 4 pixels and each sample requires 1 byte. In either case, 12 bytes are required for each group of four pixels. In either of these cases, each picture uses generally twice the memory of the initial example, and therefore the picture buffer size in terms of the number of picture storage buffers should be generally half. One exemplary set of relations to determine MaxDpbSize may be as follows:

```
  if ( PicSizeInSamplesY <= ( MaxLumaPS >> 2) )
    MaxDpbSize = Min( 4 * MaxDpbPicBuf/2, 16 )
  else if ( PicSizeInSamplesY <= ( MaxLumaPS >> 1 ) )
    MaxDpbSize = Min( 2 * MaxDpbPicBuf/2, 16 )
  else if ( PicSizeInSamplesY <= ( MaxLumaPS << 1) / 3 )
    MaxDpbSize = Min( (4 * MaxDpbPicBuf) / 6, 16 ))
  else if ( PicSizeInSamplesY <= ( ( 3 * MaxLumaPS ) >> 2) )
    MaxDpbSize = Min( (4 * MaxDpbPicBuf) / 6, 16 )
  else
    MaxDpbSize = MaxDpbPicBuf/2
  where MaxLumaPS is specified in FIG. 9 and MaxDpbPicBuf is equal to
6.
```

With MaxDpbPicBuf having a value of 6, the following values are determined:

MaxDpbSize = Min( 4 * MaxDpbPicBuf/2, 16) is 12;
MaxDpbSize = Min( 2 * MaxDpbPicBuf/2, 16) is 6;
MaxDpbSize = Min( (4 * MaxDpbPicBuf)/ 6 >> 1, 16) is 4;
MaxDpbSize = Min( (4 * MaxDpbPicBuf) / 6, 16) is 4;
Otherwise, MaxDpbSize = MaxDpbPicBuf is 3.

For another example, sps_max_dec_pic_buffering[HighestTid]<=MaxDpbSize, where MaxDpbSize is derived as specified by the bit depth is 8 and chroma format is 4:2:2. Chroma format 4:2:2 has no luminance subsampling and the two chroma components are sampled at half the sample rate of luma in the horizontal direction, namely 2. Thus the number of samples would be 8 for each group of 4 pixels and each sample requires 1 byte. Hence 8 bytes are required for each group of four pixels. Each picture uses generally 4/3 of the memory of the initial example, and therefore the picture buffer size in terms of the number of picture storage buffers should be generally less. One exemplary set of relations to determine MaxDpbSize may be as follows:

```
  if ( PicSizeInSamplesY <= ( MaxLumaPS >> 2) )
    MaxDpbSize = Min( 3 * MaxDpbPicBuf, 16 )
  else if ( PicSizeInSamplesY <= ( MaxLumaPS >> 1 ) )
    MaxDpbSize = Min( (3 * MaxDpbPicBuf) >> 1, 16 )
  else if ( PicSizeInSamplesY <= ( MaxLumaPS << 1) / 3 )
    MaxDpbSize = Min( (3 * MaxDpbPicBuf) / 3, 16 )
  else if ( PicSizeInSamplesY <= ( ( 3 * MaxLumaPS ) >> 2) )
    MaxDpbSize = Min( (3* MaxDpbPicBuf) / 3, 16 )
  else
    MaxDpbSize = MaxDpbPicBuf/1.5
where MaxLumaPS is specified in FIG. 9 and MaxDpbPicBuf is equal to 6.
```

With MaxDpbPicBuf having a value of 6, the following values are determined:

MaxDpbSize = Min( 3 * MaxDpbPicBuf, 16) is 16;
MaxDpbSize = Min( (3 * MaxDpbPicBuf) >> 1, 16 ) is 9;
MaxDpbSize = Min( (3 * MaxDpbPicBuf) / 3, 16 ) is 6;
MaxDpbSize = Min( (3* MaxDpbPicBuf) / 3, 16) is 6;
Otherwise, MaxDpbSize = MaxDpbPicBuf/1.5 is 4.

For another example, sps_max_dec_pic_buffering[HighestTid]<=MaxDpbSize, where MaxDpbSize is derived as specified by the bit depth is >8 and <=16 and the chroma format is 4:2:2. There are 8 samples for each group of four pixels and each sample uses 2 bytes; hence 16 bytes are required for each group of four pixels. Each picture uses generally 8/3 of the memory of the initial example, and therefore the picture buffer size in terms of the number of picture storage buffers should be substantially less. One exemplary set of relations to determine MaxDpbSize may be as follows:

```
  if ( PicSizeInSamplesY <= ( MaxLumaPS >> 2) )
    MaxDpbSize = Min( 3 * MaxDpbPicBuf/2, 16 )
  else if ( PicSizeInSamplesY <= ( MaxLumaPS >> 1 ) )
    MaxDpbSize = Min((4 * MaxDpbPicBuf) / 6, 16 )
  else if ( PicSizeInSamplesY <= ( MaxLumaPS << 1) / 3 )
    MaxDpbSize = Min( (3 * MaxDpbPicBuf) / 6, 16 ))
  else if ( PicSizeInSamplesY <= ( ( 3 * MaxLumaPS ) >> 2) )
    MaxDpbSize = Min( (3 * MaxDpbPicBuf) / 6, 16 )
  else
    MaxDpbSize = (3 * MaxDpbPicBuf) / 8
  where MaxLumaPS is specified in FIG. 9 and MaxDpbPicBuf is equal to
6.
```

With MaxDpbPicBuf having a value of 6, the following values are determined:

MaxDpbSize = Min( 3 * MaxDpbPicBuf/2, 16 ) is 9;
MaxDpbSize = Min((4 * MaxDpbPicBuf) / 6, 16) is 4;
MaxDpbSize = Min( (3 * MaxDpbPicBuf) / 6, 16 )) is 3;
MaxDpbSize = Min( (3 * MaxDpbPicBuf) / 6, 16 ) is 3;
Otherwise, MaxDpbSize = (3 * MaxDpbPicBuf) / 8 is 2.

For another example, sps_max_dec_pic_buffering[HighestTid]<=MaxDpbSize, where MaxDpbSize is derived as specified by the bit depth is >8 and <=16 and the chroma format is 4:4:4. There are 12 samples for each group of four pixels and each sample uses 2 bytes; hence 24 bytes are required for each group of four pixels. Each picture uses generally four times of the memory of the initial example, and therefore the picture buffer size in terms of the number of picture storage buffers should be substantially less. One exemplary set of relations to determine MaxDpbSize may be as follows:

```
  if ( PicSizeInSamplesY <= ( MaxLumaPS >> 2) )
    MaxDpbSize = Min( 4 * MaxDpbPicBuf/4, 16 )
  else if ( PicSizeInSamplesY <= ( MaxLumaPS >> 1 ) )
    MaxDpbSize = Min( 2 * MaxDpbPicBuf/4, 16 )
  else if ( PicSizeInSamplesY <= ( MaxLumaPS << 1) / 3 )
    MaxDpbSize = Min( (4 * MaxDpbPicBuf) / 12, 16 ))
  else if ( PicSizeInSamplesY <= ( ( 3 * MaxLumaPS ) >> 2) )
    MaxDpbSize = Min( (4 * MaxDpbPicBuf) / 12, 16 )
  else
    MaxDpbSize = MaxDpbPicBuf/6
  where MaxLumaPS is specified in FIG. 9 and MaxDpbPicBuf is equal to
6.
```

With MaxDpbPicBuf having a value of 6, the following values are determined:

MaxDpbSize = Min( 4 * MaxDpbPicBuf/4, 16 ) is 6;
MaxDpbSize = Min( 2 * MaxDpbPicBuf/4, 16) is 3;
MaxDpbSize = Min( (4 * MaxDpbPicBuf) / 12, 16 ) is 2;
MaxDpbSize = Min( (4 * MaxDpbPicBuf) / 12, 16) is 2;
Otherwise, MaxDpbSize = MaxDpbPicBuf/6 is 1.

In some cases, a generalized relationship may be used to determine suitable selections. Let bdY, bdCb, and bdCr respectively indicate the bit depth of Y, Cb, Cr, components of the current video sequence. If frame packing is used in defining the metric, then the bit depth values are used to compute the overall scale factor directly. If data is stored in a byte aligned manner (not using frame packing), then the bit depth values are rounded up to the nearest multiple of 8. For example, for 10 bit samples a value of bdY=16 may be used. In general for byte alignment, bdY=8*ceil(bdY÷8), bdCb=8*ceil(bdCb÷8), and bdCr=8*ceil(bdCr÷8). It is noted that for one channel images bdCb=bdCr=0. In general if one of the channels is not present the bit depth of that channel can be set to 0.

The scale factors for Y, Cb, and Cr components with respect to a 4:2:0 subsampling may be Sy, SCb, sCr as follows:

| | 4:2:0 | 4:2:2 | 4:4:4 |
|---|---|---|---|
| sY | 1 | 1 | 1 |
| sCb | 1 | 2 | 4 |
| sCr | 1 | 2 | 4 |

The overall scale factor may be computed as follows:

sF=((4*sY*bdY+sCb*bdCb+sCr*bdCy)÷(6*8), where 6 is the number of samples of 4:2:0 for normalization and 8 is the bit depth of a byte. For 8-bit 4:2:0 format the scale factor sF=1.

In some cases an alpha (e.g., blending factor) may be included in the scale factor so that the number of picture storage buffers is suitable. The alpha channel may include sA which is relative to the number of luma samples (e.g., sA=4 if there is an alpha sample for each luma sample), and bdA which is relative to the bit depth.

An exemplary scale factor may be as follows:

sF=((4*sY*bdY+sCb*bdCb+sCr*bdCy+sA*bdA)÷(6*8), where 6 is the number of samples of 4:2:0 for normalization and 8 is the bit depth of a byte.

For example, MaxDpbSize may be specificed as follows when the bit depth is equal to 8 and the chroma format of the picture is 4:2:0 together with the updated scaling factor (e.g., alpha channel).

```
  if ( PicSizeInSamplesY <= ( MaxLumaPS >> 2) )
    MaxDpbSize = Min( 4 * MaxDpbPicBuf/sF, 16 )
  else if ( PicSizeInSamplesY <= ( MaxLumaPS >> 1 ) )
    MaxDpbSize = Min( 2 * MaxDpbPicBuf/sF, 16 )
  else if ( PicSizeInSamplesY <= ( MaxLumaPS << 1) / 3 )
    MaxDpbSize = Min( (3 * MaxDpbPicBuf/sF) >> 1, 16 )
  else if ( PicSizeInSamplesY <= ( ( 3 * MaxLumaPS ) >> 2) )
    MaxDpbSize = Min( (4 * MaxDpbPicBuf/sF) / 3, 16 )
  else
    MaxDpbSize = MaxDpbPicBuf/sF
    where MaxLumaPS is specified in FIG. 9 and MaxDpbPicBuf is equal
to 6.
```

In addition, the scale factor may be applied with respect to different chroma formats, different reference chroma formats, different bit depths, and different reference bit depths. Moreover, as illustrated in FIG. 9, the bitstream may confirm to different tier and levels as indicated by syntax elements in the bitstream. By way of example, the tier and level to which the bitstream conforms may be indicated by the syntax elements general_tier_flag and general_level_idc. The general_tier_flag equal to 0 indicates conformance to the main tier, and general_tier_flag equal to 1 indicates conformance to the high tier, according to the tier constraint specifications in FIG. 9. The general_tier_flag may be equal to 0 for levels below level 4 (corresponding to the entries in FIG. 9 marked with “−”). Level limits other than MaxBR and MaxCPB in FIG. 9 may be common for both the main tier and the high tier. The general_level_idc may be set equal to a value of 30 times the level number specified in FIG. 9.

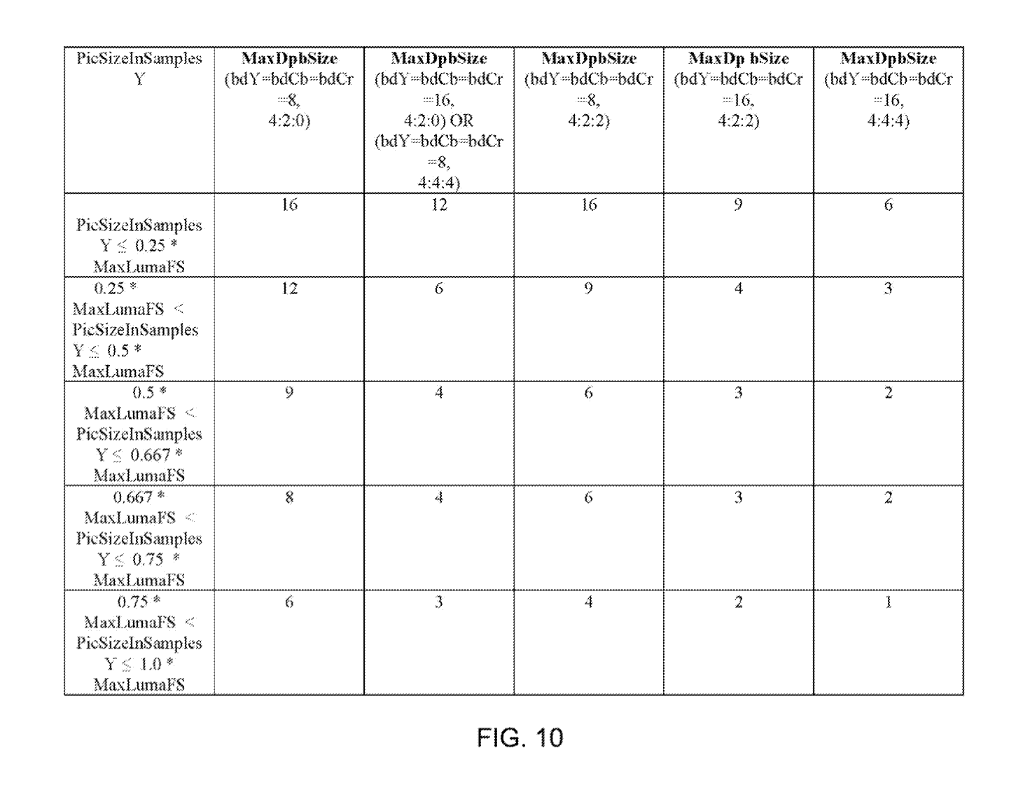

Referring to FIG. 10, example values for MaxDpbSize are calculated based on the embodiments above for various bit depths and chroma formats, where MaxDpbSize values os MaxDpbPicBuf=6.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for decoding a video bitstream comprising:
(a) receiving a frame of said video that includes a group of square coding units adjacent to one another that at group to form a coded tree block, at least one slice and at least one tile, a group of coded three blocks are included within said at least one slice, a group of coded tree blocks are included within said at least one tile, where each of said at least one slice and said at least one tile are not all aligned with one another, wherein each of said at least one tile is characterized that it is decoded independently of the other said at least one tile including intra-prediction information, motion information, wherein each of said at least one tile is characterized that it is a rectangular region of said frame and having coding units for said decoding, wherein said at least one tile of said frame are collectively arranged in a raster scan order of said frame.
